(19) United States
(12) Patent Application Publication
(10) Pub. No.: US 2006/0112569 A1
(43) Pub. Date: Jun. 1, 2006

(54) Handle assembly for a hand-held circular saw

(76) Inventors: Konstantin Baxivanelis, Kaufering (DE); Franz-Paul Mayr, Hechenwang (DE); Jean-Louis Keraudren, Stuttgart (DE)

Correspondence Address: ABELMAN, FRAYNE & SCHWAB, 666 THIRD AVENUE, 10TH FLOOR, NEW YORK, NY, 10017, US

(21) Appl. No.: 11/290,902

(22) Filed: Nov. 29, 2005

(30) Foreign Application Priority Data
Nov. 29, 2004 (DE) 10 2004 057 613.0

(51) Int. Cl. B27B 17/00

(52) U.S. Cl. 30/381

(57) ABSTRACT

A motor-driven circular saw (2) includes a handle assembly having a main grip region (14) on which the control element (10) for operating the motor (8) is arranged and which is being grasped by a first hand (H1) of a saw user and has a soft first contact surface (22) for the first hand (H1) of the saw user to be put on, and an auxiliary grip region (16) which is being grasped a second hand (H2, H2¹) of the saw user and has a soft second contact surface (23) for the second hand (H2, H2¹) of the saw user to be put on, with the first contact surface (22) and the second contact surface (23) being formed by a soft grip element (20).

### BACKGROUND OF INVENTION

1. Field of Invention

The present invention relates to a hand-held circular saw including a motor for rotationally driving a saw blade and operable by a control element, and a handle assembly having a main grip region which is being grasped by a first hand of the saw user and on which the control element is arranged so that the motor can be operated by the hand holding the saw. The handle assembly further has an auxiliary grip region which is grasped by the second hand of the saw user so that the saw is reliably held during an operation and is precisely guided. On the main grip region, there is provided a soft contact surface that comfortably supports the user first hand.

2. Description of Prior Art

Circular saws having a handle assembly as described above enable the user to reliably hold the saw and provide for a precise guidance of the saw during an operation. The soft contact surface provides for a better gripping of the main grip region and, as discussed above, comfortable holding of the main grip region.

German Publication DE 199 38 524 discloses a circular saw having a housing with a main grip region for the first hand of the user and on which a push-button for turning the saw on and off is arranged. In a spaced relationship to the first or main grip region, there is provided an additional grip element for the second hand of the user. In the main grip region, the housing is formed of two parts, with the rear side of the main grip region which is grasped by the user first hand, being formed as an upholstered element.

The drawback of the known circular saw consists in that the auxiliary grip region is less comfortable to be held because it should be made relatively smaller in order to be able to retain a certain compactness of the circular saw. The smaller size of the auxiliary grip region results in that the auxiliary grip region, contrary to the main grip region, can be formed only to a limited extent in accordance with ergonomical principles. This can lead, in particular at a lasting operation of the circular saw, to an inconvenient holding of the saw.

Accordingly, an object of the present invention is a circular saw in which the drawback of the known saw are eliminated.

Another object of the present invention is a circular saw which insures its comfortable handling and which, at the same time, has small manufacturing costs.

### SUMMARY OF THE INVENTION

These and other objects of the present invention, which will become apparent hereinafter, are achieved by providing, on the auxiliary grip region, a further soft contact surface that, together with the soft contact surface of the main grip region, is formed by a single-piece soft grip element. In this way, with very small manufacturing costs, a good gripping and a high holding comfort of the auxiliary grip region is achieved. Because both grip regions are formed by a single grip element, a simple assembly is insured.

According to a particular advantageous embodiment of the present invention, the soft grip element is provided on the handle assembly top that extends over both the main grip region and the auxiliary grip region. Thereby, the soft grip element can be formed on or applied to the top separately from the remaining part of the saw, and is secured on the saw only upon mounting of the handle top. This further simplifies manufacturing.

Advantageously, the top has a support for supporting the grip element. This permits to form the grip element relatively thin, e.g., as a coating or a covering. This further reduces manufacturing costs.

Advantageously, the soft grip element is formed by gumming, which provides for both good gripping and comfortable holding of the saw during a lasting operation.

Advantageously, the auxiliary grip region includes a knob-shaped additional grip element and the second contact surface is provided on the additional grip element. This provides for an ergonomical formation of the auxiliary grip region which together with the soft contact surface, insures a particularly good holding of the auxiliary grip region with the second hand.

Alternatively, when the handle assembly has a handle stirrup that forms the main grip region and at least a portion of the auxiliary grip region, the second contact surface is provided on the portion of the auxiliary grip region formed by the handle stirrup. In this case, the grip element has a relatively simple shape, which again simplifies manufacturing and assembly.

It is particularly advantageous when the second contact surface has a first contact surface portion provided on the additional grip element and a second contact surface portion provided on the portion of the auxiliary grip region formed by the handle stirrup.

Thereby, there are provided altogether three grip regions that can be comfortably grasped. With three grip regions, the user, dependent on a particular use of the saw, can select for holding, in addition to the main grip region, any of two parts of the auxiliary grip region in order to hold the saw particularly good and to be able to precisely guide it.

It is advantageous when the first contact surface and the second contact surface portion each extends in a direction of a longitudinal extent of the handle stirrup over a length of at least 90 mm. Thereby, there is provided, in both the main grip region and in the auxiliary grip region, a contact surface that extends over more than 90% of a total width of the user hand, insuring a particularly comfortable grasp of a respective region with a respective hand.

The novel features so the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side elevational view of a circular saw according to the present invention;

FIG. 2 a perspective view of the saw shown in FIG. 1 with an exploded view of the stirrup handle; and

FIG. 3 a longitudinal cross-sectional view of the handle top of the handle stirrup.

### DETAILED DESCRIPTION OF THE PREFERRED EMBODIMENTS

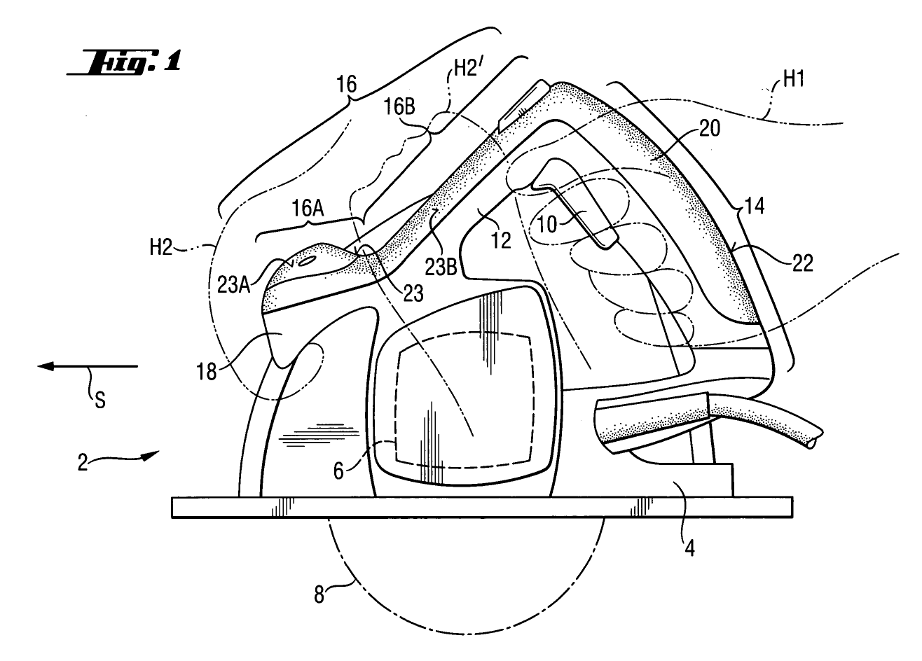

A hand-held electrical circular saw 2, which is shown in FIG. 1, includes a housing 4 in which a motor 6 for driving a disc-shaped saw blade 8 is arranged. The motor 8 is operated by a control element 10 that is formed as a push-button and is arranged on a handle stirrup 12 provided on the housing 4. The control element 10 is arranged on a main grip region 14 held during an operation by a first hand H1 of the saw user.

With the second hand H2 the user of the circular saw 2 can hold the circular saw 2 in an auxiliary grip region 16 that has a first part 16A and a second part 16B. The first part 16A is formed by a knob-shaped additional grip element 18 that projects from the handle stirrup 12 in a sawing direction S and forms, together with the handle stirrup 12, a handle assembly of the circular saw 2. FIG. 1 shows the position of the second hand H2 of the saw user on the additional grip element 18.

Between the first part 16A of the auxiliary grip region 16 and the main grip region 14, the handle stirrup 12 forms the second part 16B of the auxiliary grip region 16. FIG. 1 also shown the position of the second hand H2¹ on the second part 16B.

On the upper sides of the handle stirrup 12 and the additional grip element 18, there is provided soft gripping means 20 that is formed by gumming. It forms, in the main grip region 14, a first soft contact surface 22 and in the first and second parts 16A, 16B of the auxiliary grip region 16, a second soft contact surface 23 having contact surface portions 23A, 23B. As a result, the first hand H1 of the saw user comfortably rests on the main grip region 14, and the second hand H2, H2¹ comfortably rests on the first part 16A, the second part 16B, of the auxiliary grip region 16, which insures good grasping of respective grip regions.

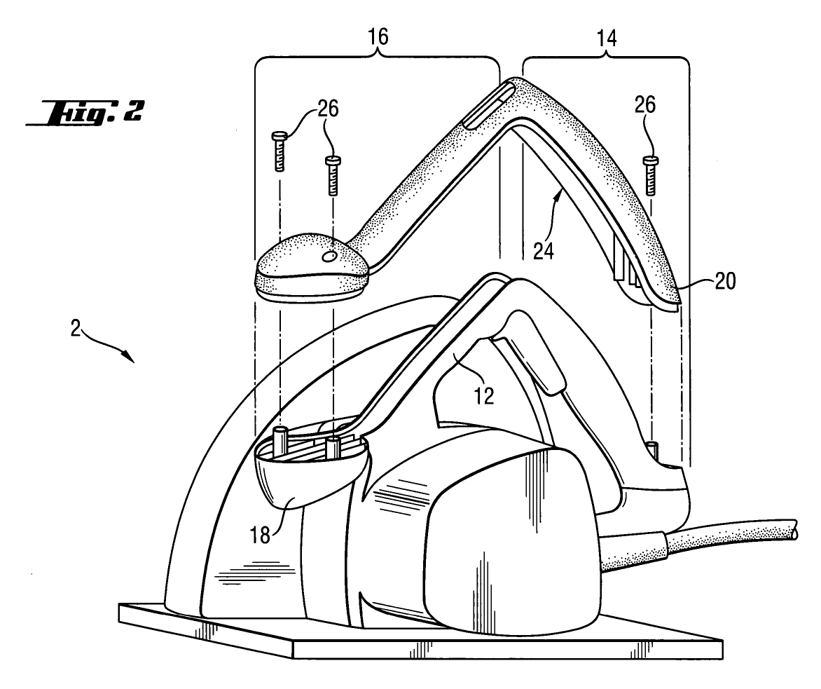

As shown in FIG. 2, the soft gripping means 20 is provided on the handle top 24 that extends over the handle stirrup 12 and the additional grip element 18 and, thus, over both the main grip region 14 and the auxiliary grip region 16. The handle top 24 is secured, during assembly of the circular saw 2, with fastening elements 26 on the upper surface of the handle stirrup 12, closing the same.

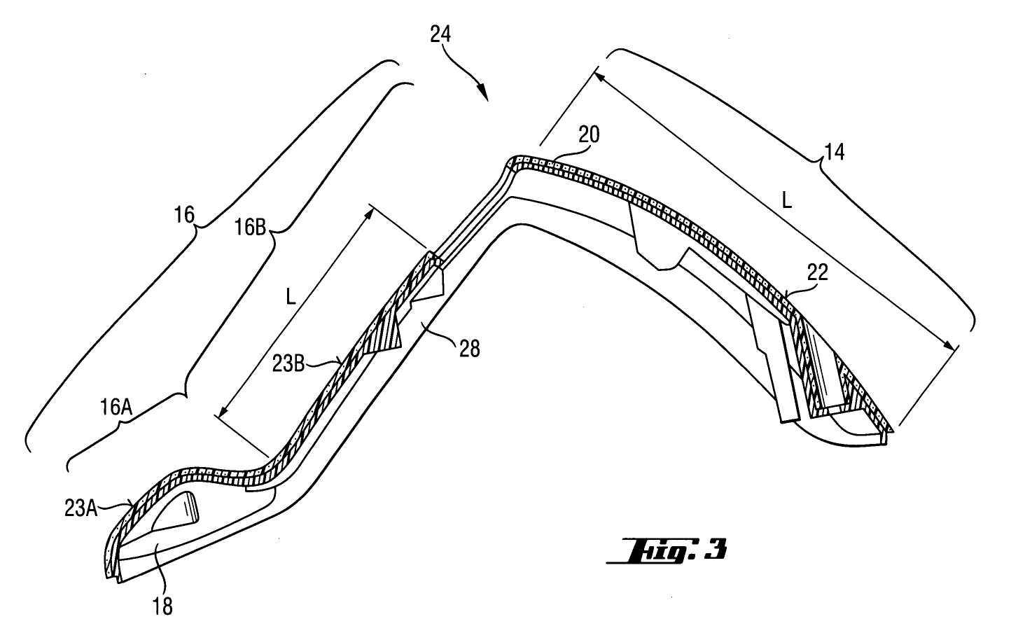

As shown in FIG. 3, the handle top 24 has a support 28 formed of a rigid plastic material and covered with the soft grip means 20. The soft grip means 20 stretches from the main grip region 14 and over the first and second parts 16A and 16B of the auxiliary grip region 16, forming the contact surface 22 and the contact surface portions 23A, 23B. The contact surface 22 and the contact surface portion 23B have, respectively, longitudinal extensions L in the main grip region 14 and the part 16B of at least 90 mm to insure, in almost all cases, a complete rest of a respective hand inner surface of the hand H1, H2¹ on, respectively, contact surface 22 and contact surface portion 23B in a corresponding direction.

Though the present invention was shown and described with references to the preferred embodiment, such is merely illustrative of the present invention and is not to be construed as a limitation thereof, and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A hand-held circular saw (2), comprising:
a motor (6) for driving a saw blade (8);
a control element (10) for operating the motor; and
a handle assembly having a main grip region (14) on which the control element (10) is arranged and which is being grasped by a first hand (H1) of a saw user and has a soft first contact surface (22) for the first hand (H1) of the saw user to be put on, and an auxiliary grip region (16) which is being grasped by a second hand (H2, H2¹) of the saw user and has a soft second contact surface (23) for the second hand (H2, H2¹) of the saw user to be put on, the first contact surface (22) and the second contact surface (23) being formed by a single-piece soft grip element (20).

2. A hand-held circular saw according to claim 1, wherein the handle assembly has a top (24) extending over both the main grip region (14) and the auxiliary grip region (16), and the soft grip element (20) is provided on the top (24).

3. A hand-held circular saw according to claim 2, wherein the top (24) has a support (28) for supporting the grip element (20).

4. A hand-held circular saw according to claim 1, wherein the soft grip element (20) is formed by gumming.

5. A hand-held circular saw according to claim 1, wherein the auxiliary grip region (16) includes a knob-shaped additional grip element (18), and the second contact surface (23) is provided on the additional grip element (18).

6. A hand-held circular saw according to claim 1, wherein the handle assembly has a handle stirrup (12) forming the main grip region (14) and at least a portion (16B) of the auxiliary grip region (16), and the second contact surface (23) stretches over the at least a portion (16B) of the auxiliary grip region (16) formed by the handle stirrup (12).

7. A hand-held circular saw according to claim 6, wherein the auxiliary grip region (16) includes an additional grip element (18), and the second contact surface (23) has a first contact surface portion (23A) provided on the additional grip element (18) and a second contact surface portion (23B) provided on the at least a portion (16B) of the auxiliary grip region (16) formed by the handle stirrup (12).

8. A hand-held circular saw according to claim 7, wherein the first contact surface (22) and the second contact surface portion (23B) each extends in a direction of a longitudinal extent of the handle stirrup (12) over a length (L) of at least 90 mm.
